(19) United States
(12) Patent Application Publication
(10) Pub. No.: US 2002/0080542 A1
(43) Pub. Date: Jun. 27, 2002

(54) Apparatus and method for protecting a load from fluctuations in supply voltage

(76) Inventors: Anthony-Cernan Mendoza, Calgary (CA); Chi Thuong Ha, Calgary (CA)

Correspondence Address: Martin J. Moran, Cutler-Hammer Products, Technology and Quality Center, 170 Industry Drive-RIDC Park West, Pittsburgh, PA, 15275, US

(21) Appl. No.: 09/747,055

(22) Filed: Dec. 22, 2000

(51) Int. Cl. H02H 3/26

(52) U.S. Cl. 361/90; 361/85; 361/93.2

(57) ABSTRACT

A power switch connecting a load to an ac source is turned off when the RMS value of the supply voltage is outside selected limits and is turned back on when the RMS voltage returns to within the limits. Adaptive hysteresis is applied to the switch controller to eliminate chattering of the power switch when the voltage fluctuates around the selected limits. To this end, the selected limits are repetitively, incrementally narrowed each time the power switch is turned off and back on a selected number of times, such as twice, within a selected time interval. The RMS voltage is rapidly determined from samples gathered over ¼ cycle so that the voltages in a three phase system can be successively repetitively calculated. Phase loss is rapidly determined by checking for the leading edge of a square wave generated from the supply voltage wave form.

### BACKGROUND OF THE INVENTION

1. Field of the Invention

This invention relates to load monitoring through the use of a switch which disconnects the load from the source when the voltage is outside selected limits and turns the switch back on when the voltage returns to within the selected limits. In particular, it relates to eliminating chatter of the switch when the voltage fluctuates around the selected limits by introducing adaptive hysteresis into control of the switch and also to a simple rapid apparatus and method for detecting phase loss.

2. Background Information

Various types of voltage monitoring apparatus are known that disconnect a load if the supply voltage deviates from preset limits. The load is reconnected when the voltage is again within the limits. A problem associated with this disconnecting and reconnecting high current loads is that the voltage level can fluctuate within a few cycles about the trip settings causing the load to be turned off and on in rapid succession. The introduction of hysteresis into the control circuit of the switch connecting and disconnecting the load can prevent the rapid oscillation or instability when the voltage level is close to the set limits. Typically, this hysteresis is provided by the introduction of feedback to the input of an analog comparator from the comparator output or by use of a time delay circuit. Both of these approaches introduce a fixed hysteresis into the control circuit and will not automatically accommodate for various levels of voltage fluctuation. Sufficient hysteresis can be introduced into the control circuit to reduce the susceptibility of the monitor to voltage fluctuations; however, the accuracy of the monitor is degraded.

Another problem for voltage monitoring is the increased generation of harmonics in power circuits resulting in great part from the widespread utilization of power switching semiconductor devices. Most of the present day voltage monitoring devices monitor the peak or average voltage. While the damaging heating effects of an ac waveform represented by the RMS value can readily be determined from the peak value for a pure sinusoidal waveform, harmonics cause the ac waveform to distort. One effect is the flattening of the top of the waveform. In such a case, the RMS value of the waveform is not readily determinable from the peak value. Peak detecting and average voltage monitoring circuits that are calibrated for sinusoidal waveforms will not turn off the power to the load if the peak voltage limit is not reached. However, the RMS value of the voltage waveform can be above the rating of the load and cause damage.

Another common function of voltage monitors is detection of loss of a phase. When an overvoltage occurs in a three-phase system, one phase might be shorted to ground. Typical approaches to loss of phase detection employ calculation and can require a half cycle.

There is a need, therefore, for improved apparatus and method for protecting loads from fluctuating ac supply voltages.

### SUMMARY OF THE INVENTION

This need and others are satisfied by the invention which is directed to apparatus for protecting a load from fluctuations in ac supply voltage by utilization of adaptive hysteresis to eliminate chattering of an electrically controlled switch which disconnects the load when the supply voltage is outside of selected limits and reconnects the load by closing the switch when the voltage returns to within the limits. In particular, the apparatus comprises an electrically controlled switch connecting a load to the ac source, a voltage monitor monitoring the voltage applied to the load, and a controller. The controller includes means turning the switch off when the voltage applied to the load is outside selected limits and turns the switch back on when the voltage returns to within the selected limits. The controller further includes adjusting means detecting chattering of the switch and progressively adjusting the selected limits from preselected base limit values until the chattering is eliminated. By chattering, it is meant that the switch turns off and on rapidly. Chattering can be measured by the number of times that the switch is turned off and back on within a predetermined time interval. The adjusting means can include means incrementally progressively adjusting the selected limits until this chattering of the switch is eliminated. The adjusting means further includes reset means resetting the selected limits to the preselected base limits upon the occurrence of a predetermined condition, which in the exemplary embodiment of the invention is the absence of chattering for a predetermined time period.

The voltage monitor digitizes the supply voltage and utilizes samples of the voltage generated over one quarter cycle. Preferably, the samples taken over one quarter cycle are used to generate an RMS value for the voltage. This rapid determination of the RMS voltage using samples gathered over one quarter cycle is particular advantageous in a three-phase ac system where the RMS voltage in the three phases is generated from samples taken in successive quarter cycles of the three phases.

The invention also embraces apparatus for rapidly detecting a phase loss. Apparatus converts the ac waveform to a square wave and then detects the leading edge of the square wave. Absence of the leading edge indicates a phase loss. This apparatus can include means which looks for a square wave to reach a predetermined amplitude within a designated time interval after a zero crossing.

The invention also embraces a method of protecting a load from fluctuations in supply voltage applied to the load through an electronic switch by monitoring the ac voltage, turning the switch off when the voltage exceeds selected limits and turning the switch back on when the voltage returns within the selected limits, detecting chattering of the switch and progressively adjusting the selected limits from preselected base limit values until the chattering is eliminated. The limits can be progressively adjusted by incrementally adjusting the selected limits until the chattering ceases. Also, the chattering can be detected by counting the number of times the switch is turned off and then on within a selected time interval. The monitoring of the voltage can be effected by use of digital samples over one quarter cycle, and for a multiphase system using samples taken in one quarter cycles of each phase. The method also includes monitoring the voltage in a multiphase system for phase loss by generating a square wave from the ac voltage and checking for the leading edge of the square wave. The leading edge of the square wave can be detected by checking for a predetermined amplitude of the square wave within a designated period of time after a projected zero crossing.

### BRIEF DESCRIPTION OF THE DRAWINGS

A full understanding of the invention can be gained from the following description of the preferred embodiments when read in conjunction with the accompanying drawings in which:

FIG. 1 is a block diagram of an electrical system incorporating the invention.

FIG. 2 is a schematic diagram of the system of FIG. 1.

FIG. 3 is a flow chart for a program which determines the RMS voltage in accordance with the invention.

FIGS. 4a and 4b taken together illustrate a flow chart of a program for eliminating chatter of the switches in the system described in FIG. 1.

FIG. 5 is a timing diagram illustrating the operation of the program of FIGS. 4a and 4b.

### DESCRIPTION OF THE PREFERRED EMBODIMENTS

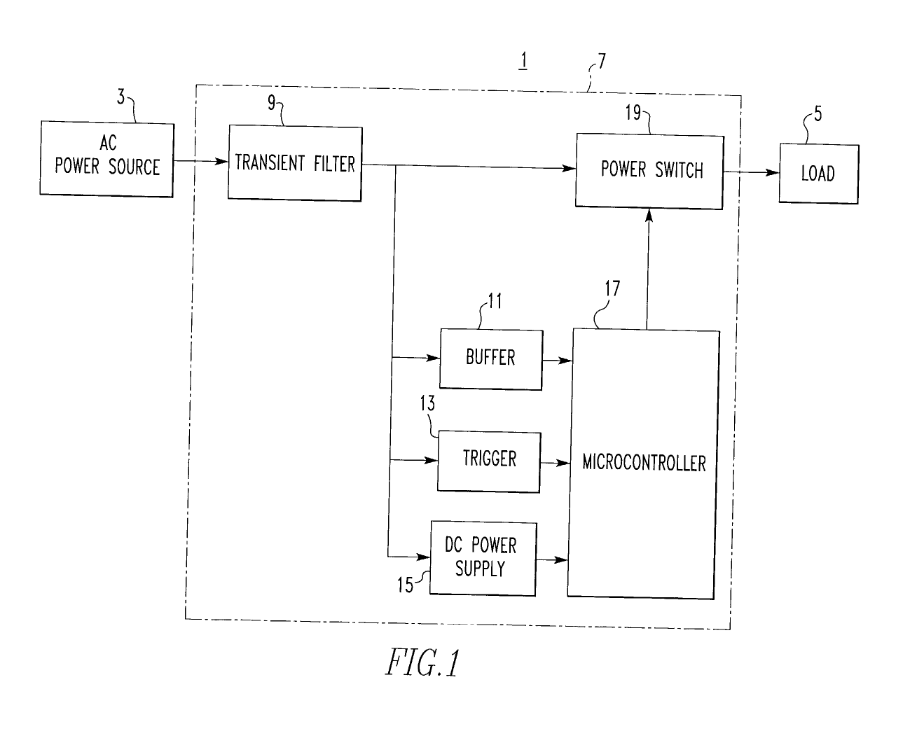

FIG. 1 illustrates an ac electric power system 1 in which an ac power source 3 provides power to a load 5. Apparatus in the form of a voltage monitor 7 protects the load 5 from fluctuations in the voltage provided by the ac source 3. The line voltage monitor 7 has six major components: a transient filter 9, a buffer 11, a trigger 13, a dc power supply 15, a microcontroller 17, and a power switch 19. The exemplary ac power system 1 is three phase; however, it is shown in single line form in FIG. 1 for clarity.

The transient filter 9 is a low pass filter which protects the load 5 and the input circuitry of the line voltage monitor from rapidly rising voltage transients. The buffer 11 provides matching of the input impedance of the microcontroller 17 with that of the input supply voltage, which as will be seen, is reduced by voltage dividers. The dc power supply 15 provides power for the microcontroller 17 and its associated circuits. The trigger 13 initiates sampling of the ac voltages, and also provides a signal when there is a phase loss. The power switch 19 connects and disconnects the load 5 from the ac source 3 under the control of the microcontroller 17.

The microcontroller 17 digitizes samples of the analog voltages. The digital samples are taken over a quarter cycle for processing by the microcontroller to generate an RMS value of each voltage. When the RMS voltage exceeds selected limits, that is goes above a selected high limit or below a selected low limit, the microcontroller 17 turns the power switch 19 off, which in turn turns off the power to the load 5. When the power is again within the limits, the microcontroller turns the power switch 19 back on.

Should the ac voltage fluctuate, causing the power switch 19 to chatter, that is to rapidly turn off and on, the microcontroller progressively adjusts the limits by narrowing them through lowering the upper limit and raising the lower limit until the chattering is eliminated. This is accomplished by the microcontroller 17 by progressively incrementally adjusting the selected limits until the chattering terminates. The chattering is detected by counting the number of times that the power switch 19 is turned off and back on within a selected time interval. In the exemplary embodiment of the invention, turning off and back on of the switch twice within the time period that it takes for the switch to mechanically turn off twice and turn on twice, together with the times required to gather the samples to make the voltage measurements (the acquisition time) and the time for the microcontroller to process the sample (the processing time). Collectively, the acquisition time plus the processing time may be referred to as the detection time. As will be seen, each time the power switch 19 chatters, a count is incremented. The cumulative value of this count is used to adjust the selected limits from a preselected base limit value. Thus, when chattering is detected, the limits of the voltage monitor are narrowed. If chattering is not eliminated, the count is incremented and the selected limits are further narrowed. This process continues until the chattering is eliminated. Under predetermined conditions, in the exemplary embodiment when chattering has been eliminated for a predetermined period of time, the microcontroller resets the selected limits back to the preselected base limits. Hence, it can be seen that the selected limits for the voltage are progressively, incrementally adjusted until chattering is eliminated. Therefore, only the amount of hysteresis required to prevent chattering is introduced and therefore, accuracy is preserved as much as possible.

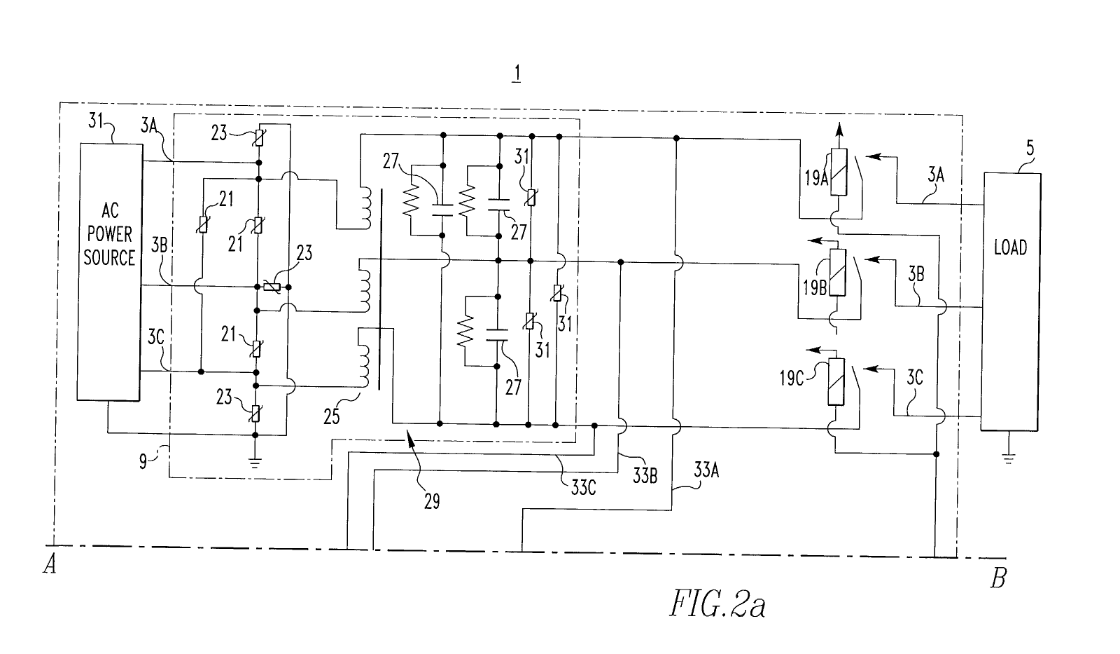

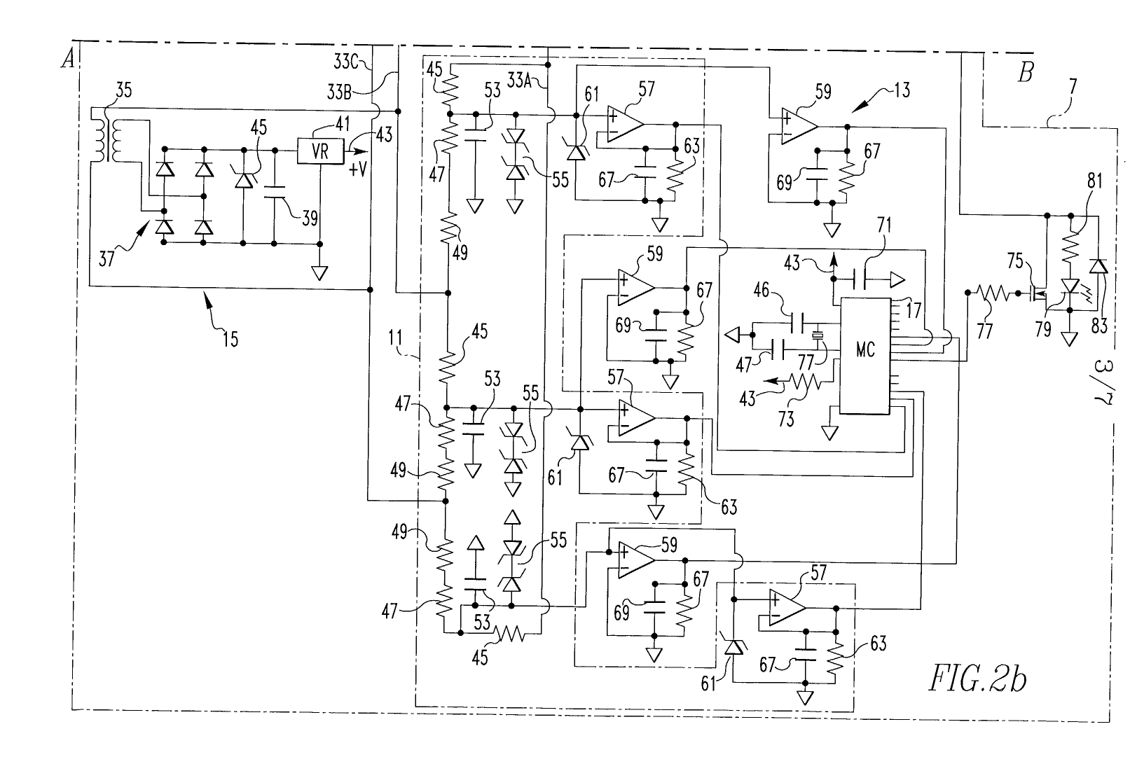

FIG. 2 is a detailed schematic diagram of the line voltage monitor 7 for protecting a three-phase load 5 from fluctuations in the three-phase supply voltage provided on the phase lines 3A-3C having a nominal voltage of 380 VAC line to line. It should be noted that the invention could be applied to single phase applications by simply reducing the number of channels.

The transient filter 9 includes metal oxide varistors (MOV) 21 which clamp voltage transients between the phase lines 3A-3C. The voltage ratings of these MOVs 21 are such that they clamp above the highest expected voltage between the lines 3A-3C. This prevents the MOVs 21 from turning on when there is a long duration of overvoltage, e.g., more than one half cycle. During this condition, the microcontroller 17 turns off relays 19A-19C which form the power switch 19, thereby preventing the load 5 from seeing the overvoltage condition.

Additional MOVs 23 provide common mode transient protection. Three phase coil 25 and capacitors 27 form a low pass filter 29, which filters high frequency transients. The low pass filter 29 also attenuates high frequency signals greater than one half the sampling rate of the microcontroller 17, thereby operating as an anti-aliasing filter.

MOVs 31 provide secondary protection by clamping any voltage transient remnants. The transient filter 9 protects both the load 5 and the remainder of the line voltage monitor 7 from high frequency voltage disturbances, i.e., noise, on the phase lines 3A-3C. The filtered voltage output from the transient filter 9 is supplied on the leads 33A-33C to the buffer 11, trigger 13, and the dc power supply 15. This dc power supply 15 includes an input transformer 35 which is connected to the lead 33B and 33C. The transformer 59 feeds a bridge rectifier 37, which in conjunction with a capacitor 39 and voltage regulator 41, provides regulated dc power on lead 43. A zener diode 45 connected across the bridge 37 prevents the voltage from exceeding the rated input voltage of the regulator 41.

The buffer 11 includes for each phase a voltage divider formed by the resistors 45, 47 and 49 that reduce the voltages from the lines 33A-33C to a level that can be processed by the microcontroller 17. Capacitors 53 and back-to-back zener diodes 55 protect the inputs of op amps 57 in the buffers and op amps 59 in the trigger 13 from voltage transients coming from the load 5. The zener diodes 55 also limit the voltage input level to five volts, which is the maximum input of microcontroller 17. The op amps 57 and 59 are LM224 or the like. Diodes 61 provide a path to ground during the negative voltage excursions of the lines 33A-33C. Therefore, only positive voltages are seen by the inputs of the op amps 57 and 59. If the diodes 61 were removed, a −VDC supply with the same values as the positive supply would be required. The diodes 61 simplify the power supply circuit. The diodes 61 are Schottky type 1N5817 which provide a low forward voltage drop. The voltage dividers formed by the network of resistors 45, 47 and 49 are scaled to the maximum range of the microcontroller 17, which in this case is 5 VDC. Due to the large values of the resistors 45, current flowing to the diodes 61 is negligible, and consequently, so is the offset voltage produced thereby. Also, using the maximum scale of microcontroller 17 reduces the effect of the offset voltage.

Op amps 57 are configured in a buffer or voltage follower configuration to match the high impedance of the voltage dividers with the low input impedance of the microcontroller 17. Resistors 63 provide a minimal load to the op amps 57. Microcontroller 17 samples each phase voltage sequentially, and during this time, only one phase is being measured and connected to the input of the microcontroller 17.

The op amps 59 of the trigger 13 generate square wave outputs on the positive half cycles of the ac voltage waveforms from the lines 33B-33C. The microcontroller 17 starts sampling when a positive pulse is detected from the output of an op amp 59. Resistors 67 provide minimum loads to the output of the op amps 59. Capacitors 69 filter noise from the op amps 59. The square waves generated by the trigger are used also in loss of phase detection.

Microcontroller 17 is an 8 bit microchip PIC16C715 with a built in four channel ADC (analog to digital converter). The internal ADC voltage reference is the dc supply voltage provided on the lead 43. It should be noted that a separate ADC and voltage reference could be used. Capacitor 71 acts as a decoupling capacitor. Resistor 73 is necessary for resetting the microcontroller 17 during power-up.

Microcontroller 17 takes 67 samples in a quarter cycle and performs an RMS computation. The RMS value of the voltage is then compared to a selected limit. When this voltage is outside the selected limits, the microcontroller 17 sends a trip signal to FET 75 through resistor 77. The FET 75 drain lead is connected directly to the negative coil terminals of the relays 19A-19C. Light emitting diode (LED) 79 serves as a simple trip visual indicator. It is on when the relays 19A-19C are off. Resistor 81 limits current flowing to the LED 79. Diode 83 protects the FET 75 from overvoltage when the relays 19A-19C are turned off.

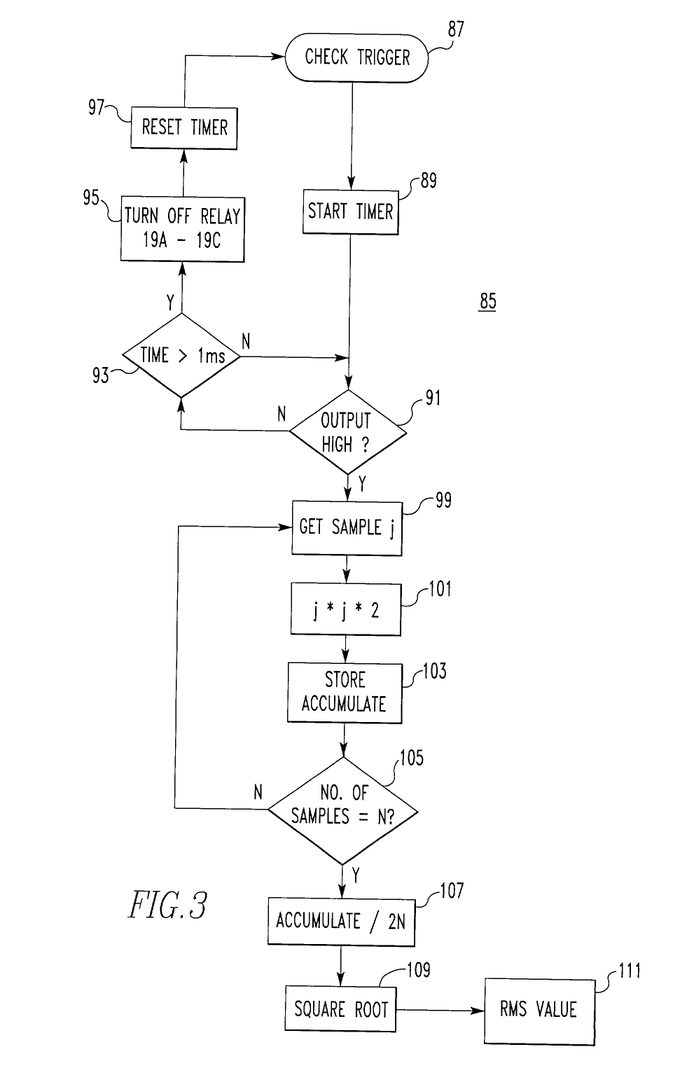

FIG. 3 illustrates the flowchart 85 implemented by the microcontroller 17 to calculate the RMS voltages. Initially during power-up, microcontroller 17 checks the phase sequence and determines which op amp 59 to check first. For example, if line 33A starts the phase sequence, then the microcontroller 17 checks first the op amp 59 connected to that line. Each time the program 85 is called for each phase, a check is made for phase loss. Thus, the output of the appropriate op amp 59 in the trigger 13 is checked at 87 and a timer is started at 89. As discussed, the microcontroller 17 checks for phase loss by looking for the leading edge of the square wave generated by the appropriate op amp 59. This is detected by determining whether output of the op amp has reached a preselected amplitude as determined at 91 within a predetermined time period, such as 1 ms, as determined at 93. If this does not occur, indicating a loss of that phase, all of the relays 19a-19c are turned off at 95 and the timer is reset at 97.

Assuming that the phase voltage is present, a loop is entered at 99 to gather and process the digitized samples j of the voltage generated by the ADC. In order to generate an RMS value of the voltage, the sample is multiplied by itself and then by 2 at 101 and added to an accumulator in 103. When the selected number of samples N have been processed as determined at 105, the accumulated value is divided by 2N at 107. The square root is then taken at 109 to generate the RMS value at 111. As the half cycles of voltage are symmetrical at the 90° point, or one quarter cycle, the voltage can be sampled for one quarter cycle with each sample value doubled. (Actually it is not necessary to double the samples as the factor of 2 is cancelled out when the accumulated value is divided by 2 times the number of samples at 107).

The number of equally spaced samples that can be taken in a quarter cycle depends upon the operating frequency of the microcontroller 17. In the exemplary system, the internal operating frequency of the microcontroller 17 was selected as 5 MHz. This permits sampling and calculation of the RMS value for sixty-seven samples in a total time of 4.25 ms. An advantage of quarter cycle sampling for a three phase system is that the phases may be successively immediately sampled in rotation for a sixty cycle wave form. As one cycle in a 60 Hz system is 16.6 ms, and the phases are 120° apart, there is 5.55 ms between the phases which is substantially less than the 4.25 ms required to calculate the RMS voltage value.

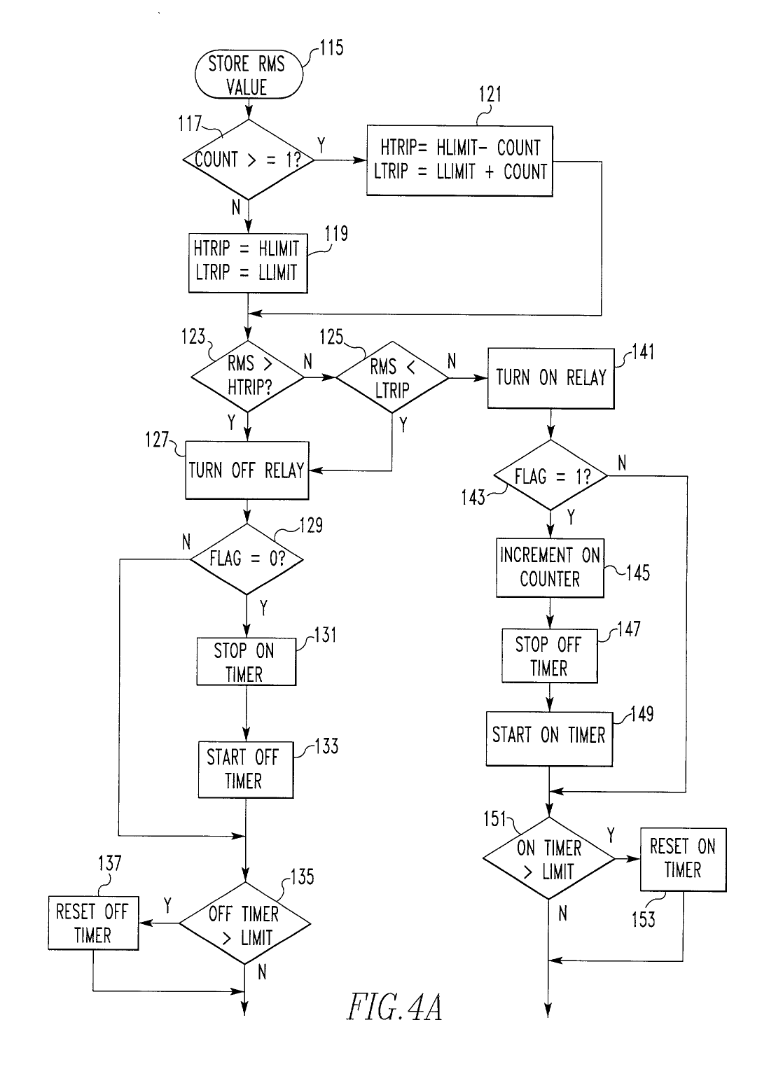

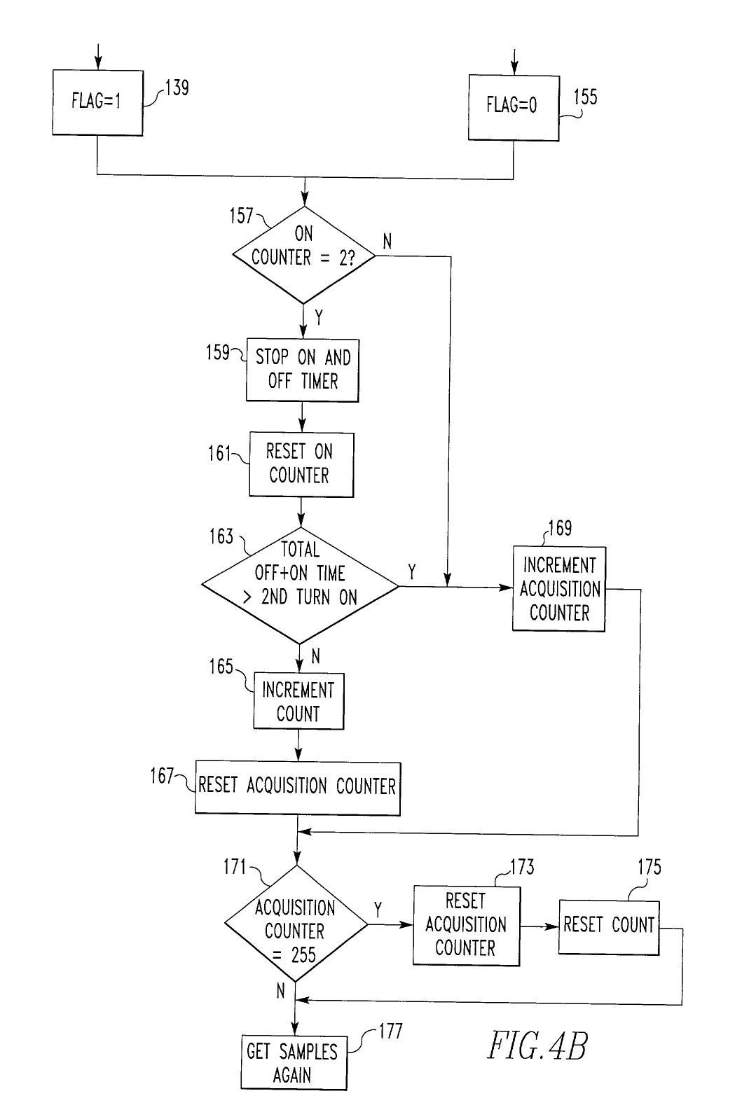

Once each cycle, the program 113 illustrated in FIGS. 4a and 4b is run. This controller program 113 controls the turning on and off of the power switch 19, including adjustment of the limits for a turn on and turn off which provide the adaptive hysteresis for the voltage monitor. This program utilizes two timers: an off timer which records the time since the power switch was turned off, and an on timer which times the time since the power switches were turned on. It also includes an ON counter which counts the number of times that the power switch has been turned on and a separate count which is the number of times that the power switch has been turned off and on twice within a selected time interval. This latter count is count of the chattering of the power switch.

The controller program 113 starts off by temporarily storing the RMS value of voltage at 115. The program 113 is run for each phase. If the count of the number of times that the power switch has been turned from ON to OFF twice within the selected time period is 0 at 117, i.e., no chattering has been detected, then the registers for the selected voltage limits are set to the preselected base values at 119. Otherwise, the selected limits are adjusted at 121 by subtracting the count for the high or positive limit and adding the count for the low or negative limit. If the measured voltage is above the high limit at 123 or below the low limit at 125, i.e., outside of the selected limits, the power switch is turned off at 127. If the flag is 0 at 129, indicating that the power switch was previously on and has just been turned off, the on timer is stopped at 131 and the off timer is started at 133. The off timer is then checked at 135 and if it is timed out, it is reset at 137. The off timer is checked at 135 also on subsequent runs of the routine where the switch has remained off and hence the flag is equal to 1 at 129. The off time limit is equal to the mechanical delay time for the switch to turn off plus the acquisition time to generate the RMS value of the voltage and plus the processing time for the microcomputer to run the program 113. Next, the flag is set to 1 at 139 if it was previously at 0.

If the RMS value of the voltage is between the limits as determined at 123 and 125, the power switch is turned ON at 141. If the power switch was previously OFF so that the flag is equal to 1 at 143, the ON counter is incremented at 145, the OFF timer is stopped at 147, and the ON timer is turned on at 149. If the ON timer has timed out at 151, it is reset at 153. The limit on the ON timer is the mechanical delay in the closing of the power switch plus the acquisition time to calculate the RMS value of voltage plus the processing time of this program. The flag is then set to 0 at 155 indicating that the power switch is closed.

Following the servicing of the appropriate timer depending upon whether the switch is ON or OFF, the ON counter is checked at 157. If the ON count equals 2, indicating that the power switch has been turned OFF and back to ON twice, the timers are turned OFF at 159 and the ON counter is reset at 161. If the total OFF plus ON time is less than the second turn on time as determined at 163, the power switch is chattering and the count is incremented at 165. The second turn on time is defined by:

2^{nd} turn On=2td+2tf+total acquisition+processing delay+ts

tf=power switch turn off delay

td=power switch turn on delay

ts=safety delay

The time tf is the time required for the power switch (relays 19A-19C) to change state from ON to OFF when the coils are deenergized. The time td is the time required for the power switch 19 (relays 19A-19C) to change states from OFF to ON when the coils are energized. The time ts is the interval that the power switch or the load could tolerate in switching from ON to OFF and the associated delay incurred by the microcontroller 17 during processing. Thus, it can be appreciated that the second turn on time is a function of the relays used and the speed of the microcontroller 17. Incrementing of the count at 165 will adjust the selected limit for turning the switch OFF and ON the next time the routine is run. After the count is incremented at 165, the acquisition counter is reset at 167. The acquisition counter is used to reset the selected limits back to the base limit values after chattering has ceased. This counter is incremented at 169 each time the routine is run if the ON counter has not reached 2 at 157. If the acquisition counter reaches a preset count, 255 in the exemplary system, as determined at 171, then the reset period has expired and the acquisition counter is reset at 173 and the count is reset at 175 so that the base limit values are restored. Following this, and also if the acquisition counter is not timed out at 171, the program awaits for the next cycle to gather another set of samples at 177.

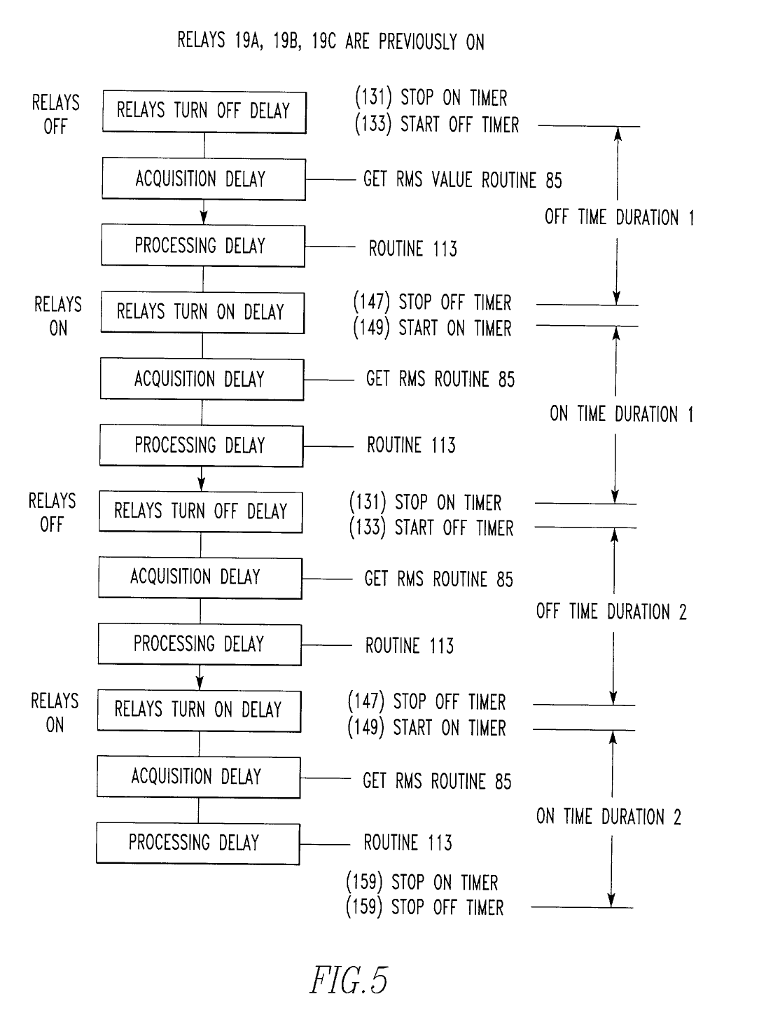

FIG. 5 illustrates the sequence and timing involved in the detection of chattering. As can be seen, the relay switches from OFF to ON twice. The first time the routine 113 is run, the relays are turned OFF. This OFF time duration 1 as can be seen equals the time for the relays to mechanically turn OFF plus the acquisition delay which is a time for the routine 85 shown in FIG. 3 to run and the processing delay which is the time for the routine 113 in FIGS. 4a and 4b to run. The numbers in parentheses refer to the steps in the routine 113. Should the voltages return to within the limits, the relays are turned on again and the ON time duration 1 is measured. If the voltage again exceeds the limits, the relays are turned off, and this second OFF time duration is measured. If again the voltage returns within the limits, the relays are turned on for a second time and a second time on duration is measured. Thus, the total elapsed ON plus OFF time is equal to the sum of the first and second OFF time durations plus the first and second ON durations. If this total time is less than the selected time interval, the relay is chattering and the limits are narrowed.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. Apparatus protecting a load in an ac electrical system from fluctuations in voltage of an ac source, said apparatus comprising:
an electrically controlled switch connecting the load to the ac source;
a voltage monitor monitoring the voltage applied to the load; and
a controller comprising:
means turning the switch off when the voltage applied to the load is outside selected limits and turning the switch back on when the voltage returns to within the selected limits; and
adjusting means detecting chattering of the switch and progressively adjusting the selected limits from preselected base limit values until the chattering terminates.

2. The apparatus of claim 1 wherein the adjusting means includes means incrementally progressively adjusting the selected limits until the chattering of the switch is eliminated.

3. The apparatus of claim 2 wherein the adjusting means includes reset means resetting the selected limits to the preselected base limit values upon a predetermined condition.

4. The apparatus of claim 3 wherein the reset means comprises means responsive to the absence of chattering for a predetermined time period as the predetermined condition for resetting the selected limits.

5. The apparatus of claim 1 wherein the adjusting means comprises means detecting chattering in response to the switch being turned off and on a selected number of times within a selected time interval.

6. The apparatus of claim 5 wherein the means detecting chattering comprises means responsive to the switch being turned off and on twice within the selected time interval.

7. The apparatus of claim 6 wherein the voltage monitor includes digitizing means periodically sampling the voltage over an acquisition period, and the controller comprises digital processing means requiring processing time, and the selected interval equals at least the cumulative times for the switch to open and close twice plus the acquisition period and the processing time.

8. The apparatus of claim 5 wherein the adjusting means includes a counter which increments each time a chattering of the switch is detected and wherein the means incrementally adjusting the selected limits adjusts the selected limits by the count in the counter.

9. The apparatus of claim 1 wherein the voltage monitor comprises means monitoring RMS voltage applied to the load.

10. The apparatus of claim 9 wherein the means monitoring RMS voltage uses digital samples of the voltage generated over one-quarter cycle.

11. The apparatus of claim 10 wherein the ac system is a three-phase ac system and the means monitoring RMS voltage comprises means monitoring RMS voltage of each phase using samples generated over successive quarter cycles of the phases.

12. Apparatus detecting a loss of phase in an ac system, said apparatus comprising:
means energized by the ac system generating a square wave from an ac wave form of the ac system; and
means detecting the leading edge of the square wave and generating a phase loss indication when the leading edge is not detected.

13. The apparatus of claim 12 wherein the means detecting the leading edge of the square wave comprises means checking for the square wave to rise to a predetermined amplitude within a designated time period after an expected zero crossing.

14. The apparatus of claim 13 wherein the ac system is a multiphase ac system and the means generating a square wave generate a square wave from an ac waveform of each phase, and the means detecting the leading edge of the square wave comprise means detecting a leading edge of the square wave for each phase and generating a loss of phase indication when the leading edge of any square wave is not detected.

15. The apparatus of claim 13 wherein the means generating the square wave comprises a comparator.

16. The apparatus of claim 12 wherein the ac system is a multiphase ac system and the means generating a square wave generates a square wave from an ac waveform of each phase, and the means detecting the leading edge of the square wave comprise means detecting a leading edge of the square wave for each phase and generating a loss of phase indication when the leading edge of any square wave is not detected.

17. A method of protecting a load from fluctuations in ac voltage applied to the load from an ac source through an ac switch comprising the steps of:
monitoring the ac voltage;
turning the switch off when the voltage exceeds selected limits and turning the switch back on when the voltage returns to within the selected limits;
detecting chattering of the switch; and
progressively adjusting the selected limits from preselected base limit values until the chattering is eliminated.

18. The method of claim 17 wherein the step of progressively adjusting the selected limits comprises incrementally progressively adjusting the selected limits until the chattering is eliminated.

19. The method of claim 18 wherein the step of detecting chattering comprises counting the number of times the switch is turned off and then on within a selected time interval.

20. The method of claim 19 wherein detecting chattering comprises counting the switch being turned off and then on twice.

21. The method of claim 20 wherein time interval comprises a time for the switch to turn off and then on twice, plus a time required to detect that the switch has been turned back on.

22. The method of claim 17 wherein monitoring the ac voltage comprises monitoring RMS voltage.

23. The method of claim 17 wherein monitoring the ac voltage includes checking for phase loss.

24. The method of claim 23 wherein checking for phase loss comprises generating a square wave from the ac voltage and checking for a leading edge of the square wave.

26. The method of claim 25 wherein checking for the leading edge of the square wave comprises checking for a predetermined amplitude of the square wave within a predetermined time period after an expected zero crossing of the square wave.

27. The method of claim 21 wherein monitoring ac voltage comprises generating a voltage value from digital samples of the ac voltage taken over one quarter cycle of the ac voltage.

28. The method of claim 27 wherein the ac system comprises a multiphase ac system and wherein monitoring the ac voltage comprises successively monitoring the ac voltage over one quarter cycle of each phase.

29. The method of claim 28 wherein monitoring ac voltages comprises monitoring RMS voltages.
